(19) United States
(12) Patent Application Publication
(10) Pub. No.: US 2010/0046534 A1
(43) Pub. Date: Feb. 25, 2010

(54) DATA TRANSMISSION APPARATUS

(75) Inventors: Hiroshi KUROSAKI, Kawasaki (JP); Satoshi Nemoto, Kawasaki (JP); Hideo Abe, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/545,899

(22) Filed: Aug. 24, 2009

(30) Foreign Application Priority Data
Aug. 25, 2008 (JP) 2008-215506

(51) Int. Cl. H04L 12/56

(52) U.S. Cl. 370/401

(57) ABSTRACT

A data transmission apparatus includes an input interface; an output interface; and a first and second switch portions which are provided between the input interface and the output interface and which transfer a frame from the input interface to a destination output interface, wherein the first and the second switch portions each include a buffer which stores the frame from the input interface according to the destination output interface, a scheduler which reads the frame from the buffer and transfers the frame to the destination output interface, and a frame amount detection portion which detects the amount of frames held in the buffer according to the destination output interface, and the scheduler controls reading from the buffer based on difference between the held frame amount of the first switch portion and the held frame amount of the second switch portion which is detected by the frame amount detection portion.

### CROSS-REFERENCE TO RELATED APPLICATION

This application is based upon and claims the benefit of priority of the prior Japanese Patent Application No. 2008-215506, filed on Aug. 25, 2008, the entire contents of which are incorporated herein by reference.

### FIELD

The embodiments discussed herein are related to a data transmission apparatus such as a Layer 2 Switch (e.g., an L2 switch, a switching hub) or Layer 3 Switch (e.g., an L3 switch) of which a switching part is redundant.

### BACKGROUND

Among L2 switches, there is a method, for example, in which frames that are inputted to every input interface are distributed to every output interface and frames addressed to a particular device are selectively downloaded and forwarded based on a full-mesh connection between a plurality of input and output interfaces.

However, with this method, there is a problem that the number of the connections among cards exponentially increases with a large-scale switch. Thus, the large-scale switch adopts a concentrated switch configuration that intensively performs switching in a switch portion that is independent of the input and output interfaces.

In this method, reliability can be increased by arranging redundant switch portions as illustrated in FIG. 1. Here, in the L2/L3 switch having the concentrated switch configuration, there is a case that the switching is performed by dividing variable length frames and packets into fixed length segments in order to execute a high rate transfer. In the following, the segments, packets, and frames may be collectively called “frames”.

In FIG. 1, two types of redundancy may be considered. One is that the frame is transferred only to one switch portion 12, which is defined as active, from the input interface 10. The other is that the frame and the copy thereof are supplied respectively to both of the switch portions 12 and 14, and the output interface 16 selects only the output from the one switch portion 12 which is defined as active. In the former type, when a fault occurs at the active switch portion 12, the frame transfer to the switch portion 12 is halted and the transfer to the switch portion 14, which is newly defined as active, is started. In the latter type, when a fault occurs at the switch portion 12, the selection at the output interface 16 is changed to select the output of the switch portion 14.

However, in both of the types, there is a problem that some frames may be omitted from the detection of fault occurrence until completing the change.

As the related art, Japanese Patent Application Laid-open No. 08-8922 has been disclosed.

### SUMMARY

According to an aspect of the invention, a data transmission apparatus includes an input interface; an output interface; and a first switch portion and a second switch portion which are provided between the input interface and the output interface and which transfer a frame from the input interface to a destination output interface, wherein the first and the second switch portions each include a buffer which stores the frame from the input interface according to a destination output interface, a scheduler which reads the frame from the buffer and transfers the frame to the destination output interface, and a frame amount detection portion which detects the amount of frames held in the buffer according to the destination output interface, and the scheduler controls reading from the buffer based on the difference between the held frame amount of the first switch portion and the held frame amount of the second switch portion which is detected by the frame amount detection portion.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an explanatory view which illustrates redundancy of a switch portion of an L2 switch;

FIG. 2 illustrates an example of a physical card configuration of the L2 switch according to the present embodiment in which the switch portion is redundant;

FIG. 3 is a functional block diagram which illustrates functions of the L2 switch of FIG. 2 in detail;

FIG. 4 illustrates a format example of a segment which is transferred within an apparatus; and

FIG. 5 is a flowchart which describes a determination process and a read-restriction control.

### DESCRIPTION OF EMBODIMENT

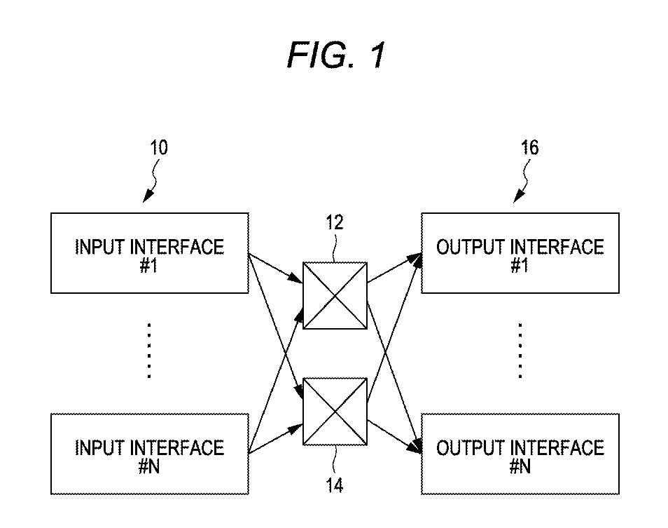

In International Application No. PCT/JP2007/072565 which was previously submitted by the applicant of this application, an apparatus having a redundant switch portion in which a frame is not omitted even when a fault occurs is proposed to solve the aforementioned problem. In the proposed apparatus, the frame and the copy thereof are supplied in parallel to the switch portions 12 and 14 from the input interface 10, as illustrated in FIG. 1.

At the output interface 16, the received frame is to be held in a buffer (not illustrated in the drawings) for a certain time. Then, concerning the same frame, the previously received frame is transferred and the subsequently received frame is discarded. Namely, an active/backup switching control is flexibly performed without defining either of the switch portions as active in a fixed manner.

In this configuration, when a fault occurs at either of the switch portions 12 or 14, the frames of switch portion which previously received frames may be continuously transferred without omission if there is a fault with the switching portion that subsequently received frames at that time. Even if there is a fault with the switch portion that previously received frames, the transferring without the frame omission may be continued by continuously transferring the frames of the switch portion which subsequently received frames.

Here, since the data transmission apparatus of a packet system basically performs non-synchronized transferring, there is a clock deviation between the switch portion 12 and the switch portion 14. When the state that the frames are held in the buffers (not illustrated in the drawings) of the switch portions 12 and 14 (congestion state) continues, the difference of the amount of the frames held in the buffers due to the clock difference gradually becomes larger. Therefore, a difference of the delay time between the frames outputted from the switch portions 12 and 14 occurs and gradually increases.

As mentioned above, even at the output interface 16, the received frames are held in the buffer at the output interface 16 for a certain time and the determination of previous receiving or subsequent receiving is performed. When the delay difference time of the frames exceeds the held time in the buffer at the output interface 16, the previously received frame is to be read from the buffer and transferred before the subsequent frame is received. Accordingly, there arises a problem that the dynamic active/backup change control system in which the previously received frame is made active without fixing one line as active cannot be continued.

In order to accept a larger delay difference, the buffer, which may accommodate the larger delay difference, is preferably provided at the output interface side. However, since the delay difference may be infinite, simply enlarging the buffer capacity may not be a perfect solution. Further, the capacity of the buffer that may be provided at the output interface is also physically limited.

Further, another method is to shorten the delay difference by synchronizing the clock of the switch portions 12 and 14 which is a method adopted by a synchronization network such as SDH/SONET. However, there is a drawback that the cost is increased due to increasing the number of parts to be included in the switch portion.

Furthermore, even if the clock is completely synchronized, the difference of the delay time gradually becomes larger when the congestion control from the output interface 16 side to the switch portions 12 and 14 (the control of frame reading from the buffer of the switch portions 12 and 14) is continuously performed in a constant cycle period not being synchronized with the switch portions 12 and 14.

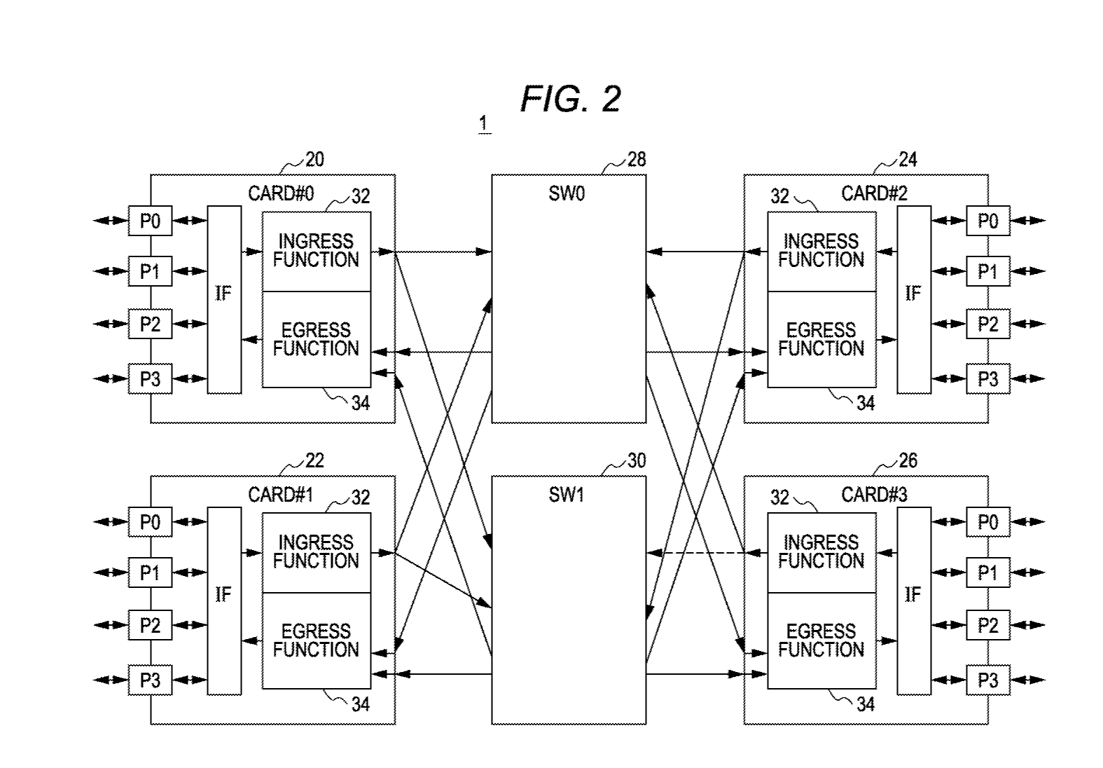

FIG. 2 illustrates an example of a physical card configuration and a switching portion that is a redundant layer 2 switch (L2SW) 1. The example illustrated in FIG. 2 is configured to include four line interface unit (LIU) cards 20, 22, 24, and 26 which respectively have four ports P0 through P3, and switch (SW) cards 28 and 30 which are configured to be redundant. Each of the LIU cards 20, 22, 24, and 26 has an ingress function 32 which corresponds to the function of the input interface 10 in FIG. 1, and an egress function 34 which corresponds to that of the output interface 16.

The frames that are inputted from the ports P0 through P3 of the LIU cards 20, 22, 24, and 26 are copied by the ingress function 32, and the original frames and the copied frames are inputted to the SW cards 28 and 30. The frame which is inputted to the SW cards 28 and 30 is transferred to the egress function 34 of one of the LIU cards 20, 22, 24, or 26 and outputted from the ports P0 through P3 in accordance with the destination thereof. Here, the input interface #i (i=1 . . . N) and the output interface #i (i=1 . . . N) in FIG. 1 are preferably coupled one-to-one so as to be on the same card as illustrated in FIG. 2.

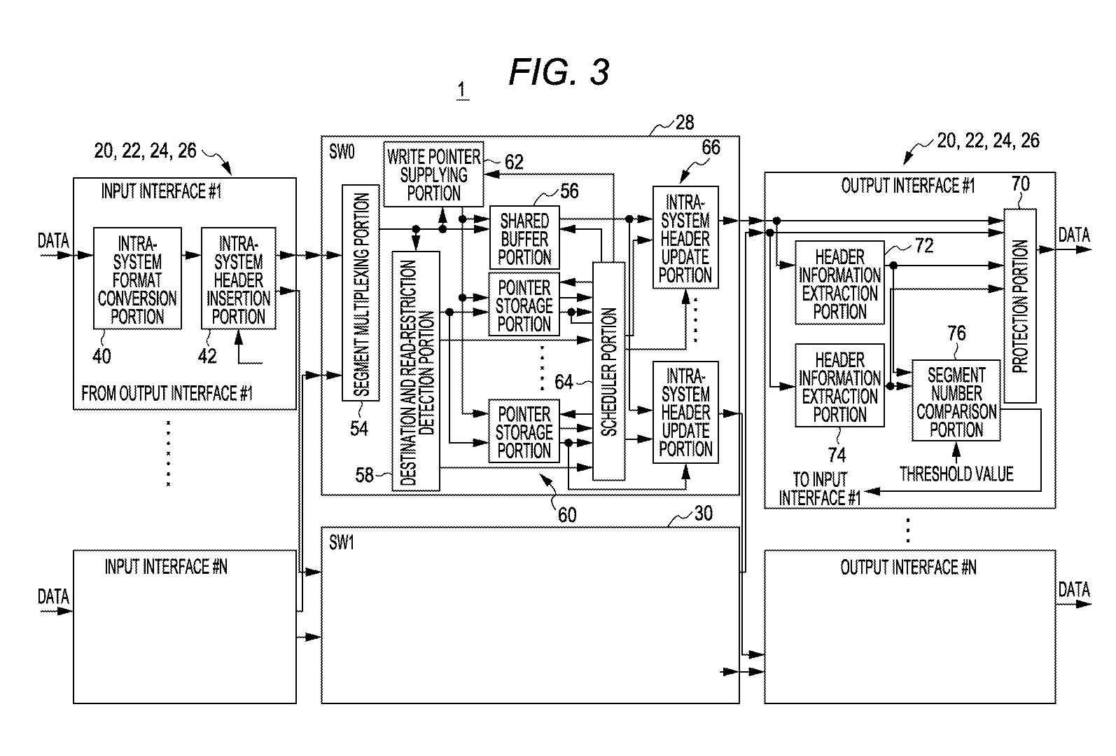

FIG. 3 is a functional block diagram illustrating a detailed example of the functions of each of the cards of the L2 switch in FIG. 2.In FIG. 3, portions corresponding to the ingress function 32 are illustrated at the left side as the input interfaces #1 to #N, and portions corresponding to the egress function 34 are illustrated at the right side as the output interfaces #1 to #N among the functions of the LIU cards 20, 22, 24, and 26 in FIG. 2. Then, concerning these functions, the input interface #i (i=1 . . . N) and the output interface #i (i=1 . . . N) are physically coupled one-to-one so as to be on the same card.

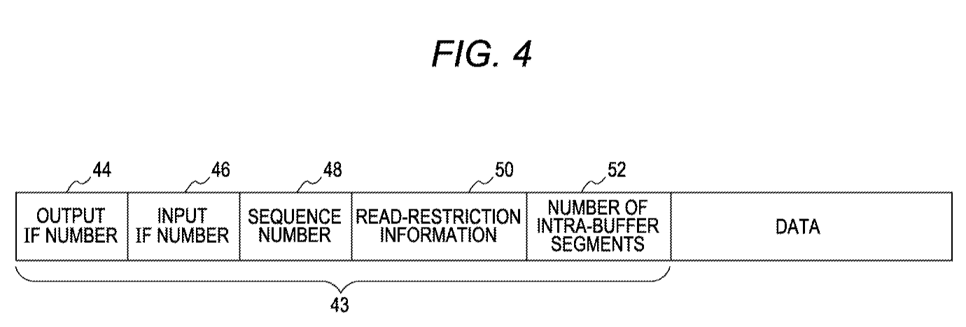

In FIG. 3, an intra-system format conversion portion 40, which is provided for each of the input interfaces #1 to #N of the LIU cards 20, 22, 24, and 26, divides the inputted frame into fixed length segments and adds an intra-system header to each of the segments. As illustrated in FIG. 4, the intra-system header 43 includes fields for an output IF (interface) number 44, an input IF (interface) number 46, a sequence number 48, read-restriction information 50, and number of intra-buffer segments 52.

A number identifying the output interface out of the output interfaces #1 to #N, which is determined from the destination address of the frame based on a learning result as the destination of the frame, is stored in the field of the output IF number 44. For example, “i” is stored when the output interface #i is the address. The number identifying the input interface out of the input interfaces #1 to #N from which the frame is inputted is stored in the field of the input IF number 46. For example, “i” is stored when the frame is inputted from the input interface #i. A serial number for each input interface assigned to each segment is stored in the field of the sequence number 48.

In FIG. 3, an intra-system header insertion portion 42 of each of the input interfaces #1 to #N of the LIU cards 20, 22, 24, and 26 sets information in the field of the read-restriction information 50 of the intra-system header 43 based on the information from the output interfaces #1 to #N. The read-restriction information is described later in detail.

The segments which are inputted to the switch portion 28 from the input interfaces #1 to #N are multiplexed into one line at a segment multiplexing portion 54. A pointer request is issued for each of the multiplexed segments from the segment multiplexing portion 54 to a write pointer supplying portion 62. The write pointer supplying portion 62 determines a storage position for storing each of the segments in a shared buffer portion 56 in accordance with the pointer request from the segment multiplexing portion 54, and supplies a pointer which indicates the determined storage position for each of the segments.

A destination and read-restriction detection portion 58 detects the output IF number 44 and the read-restriction information 50 in the intra-system header 43 of each of the segments. The detected read-restriction information is transferred to a scheduler portion 64. Each of the segments is stored in the position of the shared buffer 56 indicated by the pointer. The pointer is stored in a form of an FIFO cue at a pointer storage portion 60 according to the output IF number of the segment.

The scheduler portion 64 refers to the pointer storage portion 60 in accordance with a certain scheduling method. When a pointer is stored in the referred FIFO cue, the scheduler portion 64 reads the pointer and transfers the pointer to the shared buffer portion 56. At the shared buffer portion 56, the segment is read from the storage position indicated by the pointer and transferred to an intra-system header update portion 66 which is provided for each of the output interfaces. When the segment to be read does not exist at that time, null data is transferred to the intra-system header update portion 66. The control of the scheduler portion 64 based on the read-restriction information is described later.

The intra-system header update portion 66, which is arranged at each of the output interfaces, detects the number of the segments which are currently held in the shared buffer portion 56 for the designated output interface by referring to the FIFO cue of the pointer storage portion 60 of the corresponding output IF number. Then, the intra-system header update portion 66 sets the detected number of the segments at the field of the number of intra-buffer segments of the intra-system header 43 of the segment to be outputted. Then, the intra-system header update portion 66 transfers the segment to the corresponding output interface.

If the segment to be transferred does not exist and the null data is transferred from the scheduler portion 64, the intra-system update portion 66 generates an idle segment and sets a value of the number of intra-buffer segments, and then, transfers the value to the output interface.

The switch portion 30 (SW1), which has the same configuration as the switch portion 28 (SW0), performs the same process as the switch portion 28 on the copy of the segments stored from the input interfaces #1 to #N.

A header information extraction portion 72, which is provided at each of the output interfaces #1 to #N of the LIU cards 20, 22, 24, and 26, performs extraction of the intra-system header information from the segment which is transferred from the switch portion 28. A header information extraction portion 74 performs extraction of the intra-system header information from the segment which is transferred from the switch portion 30. Among the extracted information, information of the number of intra-buffer segments is transmitted to a segment number comparison portion 76, and information of the input IF number and the sequence number are transmitted to a protection portion 70.

The protection portion 70 stores the segments transferred from the switch portions 28 and 30 in the buffer (not illustrated in the drawings) for a certain period of time. Then, the protection portion 70 transfers the previously received segment and discards the subsequently received segment of the segments which have the same input IF number and the same sequence number. The segment number comparison portion 76 compares the number of intra-buffer segments from the header information extraction portion 72 with the number of intra-buffer segments from the header information extraction portion 74 and determines whether or not reading from the shared buffer 56 is to be restricted based on the comparison result. The details thereof are described later.

The determination result of the segment number comparison portion 76 is provided to the intra-system header insertion portion 42 of the input interface (the input interface #“i”) which is coupled to the output interface (the output interface #“i”) in which the segment number comparison portion 76 is provided. The intra-system header insertion portion 42 sets the read-restriction information 50 of the intra-system header 43 (in FIG. 4) of the passing segment based on the determination result of the segment number comparison portion 76. The scheduler portions 64 of the switch portions 28 and 30 perform the control of the read-restriction on the segment which is addressed to the output interface #i based on the read-restriction information 50 of the segment of which the input IF number is “i” (i=1 . . . N).

For example, the reading of the segment which is addressed to the output interface #3 is controlled based on the read-restriction information which is carried by the segment from the input interface #3 since the read-restriction information is based on the determination result of the segment number comparison portion 76 arranged at the output interface #3 which is coupled to the input interface #3.

With the above configuration and with the transmission of the control information with the segment which is transferred between the cards, the difference between the number of the segments held in the shared buffer 56 of the switch portion 28 and the number of the segments held in the shared buffer 56 of the switch portion 30 may be controlled for each of the output interfaces without newly adding a card.

Instead, it may be possible to have a configuration which has a separately provided control portion which directly controls the reading at the scheduler portion 64 by directly extracting and comparing information of the number of segments from the pointer storage portions 60 of the switch portion 28 and the switch portion 30. Here, since the length of each of the segments is fixed, the difference of the amount of the held segments may be controlled by controlling the difference of the number of the segments. Accordingly, the difference of the delay time may be controlled.

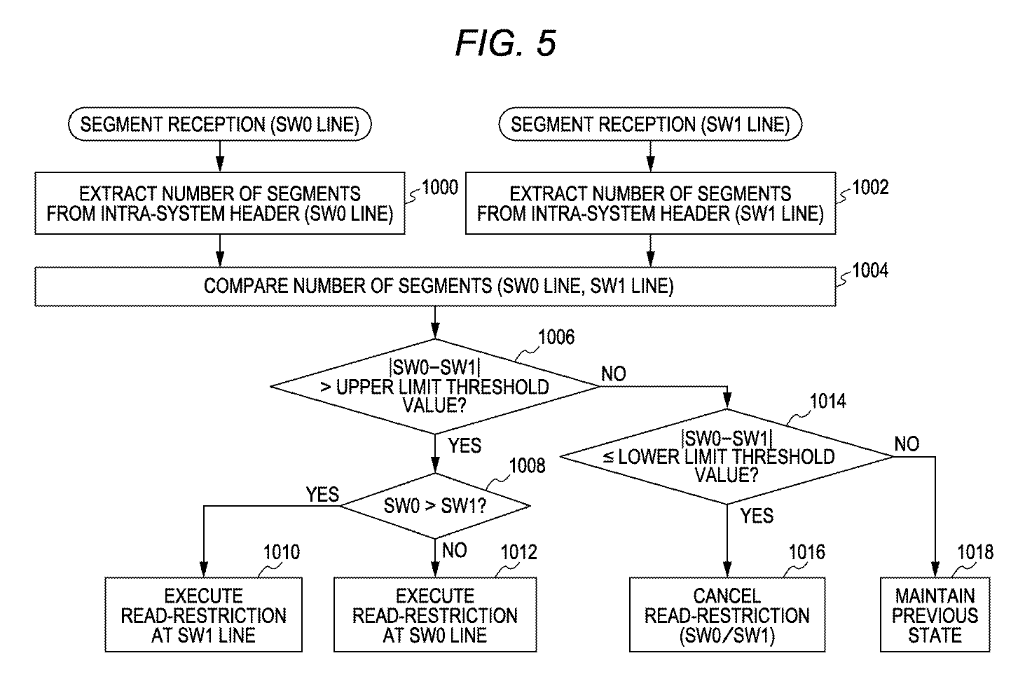

FIG. 5 is a flowchart which describes an example of the determination process and the control of the read-restriction based on the determination process. In FIG. 5, when a segment is received from the switch portion 28 (SW0 line), the output interface in FIG. 3 extracts data of the number of intra-buffer segments from the intra-system header 43 of the received segment at the header information extraction portion 72 in step 1000. Similarly, when a segment is received from the switch portion 30 (SW1 line), the output interface extracts data of the number of intra-buffer segments from the intra-system header 43 of the received segment at the header information extraction portion 74 in step 1002.

The segment number comparison portion 76 compares the number segments of both the SW0 line and the SW1 line in step 1004. When the difference of the number of segments exceeds an upper limit threshold value in step 1006, the segment number comparison portion 76 determines which is larger in step 1008. Then, the input interface which receives the determination result activates the read-restriction information 50 of the intra-system header 43 of the segment directed to the switch portion with the fewest amount of held frames and transfers the information to both of the switch portions.

The switch portion with the fewest amount of held frames controls or halts reading from the shared buffer portion 56 after receiving the information in step 1010 and step 1012. Since the rate of the segment which is inputted to the shared buffer portion 56 is the same in both of the lines, the number of segments held in the buffer with the fewest amount of frames relatively increases when the reading of the buffer is restricted. Accordingly, the difference of the number of segments is decreased.

When the difference of the number of segments is equal to or less than the upper limit threshold value in step 1006, comparison with the lower limit threshold value is performed in step 1014. Then, when the difference of the number of segments is equal to or less than the lower limit threshold value, the read-restriction is cancelled in step 1016.When the difference of the number of segments is equal to or less than the upper limit threshold value and exceeds the lower limit threshold value, the previous restriction state is maintained in step 1018.

In the present embodiment, the difference of the frames stored in the buffers of both of the switch portions which are redundant is controlled by the reading control portion so that the difference of the frame amount is not increased. Consequently, increasing of the delay time difference of the frame outputted from each of the switch portions may be prevented.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. A data transmission apparatus comprising:
an input interface;
an output interface; and
a first switch portion and a second switch portion which are provided between the input interface and the output interface and which transfer a frame from the input interface to a destination output interface,
wherein the first and the second switch portions each include a buffer which stores the frame from the input interface according to the destination output interface, a scheduler which reads the frame from the buffer and transfers the frame to the destination output interface, and a frame amount detection portion which detects the amount of frames held in the buffer for each destination output interface, and
the scheduler controls reading from the buffer based on the difference between the held frame amount of the first switch portion and the held frame amount of the second switch portion which is detected by the frame amount detection portion.

2. The data transmission apparatus according to claim 1,
wherein the input interface transfers an inputted frame and a copy thereof to the first switch portion and to the second switch portion, and
the output interface transfers a previously received frame and discards a subsequently received frame out of the frame and the copy thereof from the first and the second switch portions.

3. The data transmission apparatus according to claim 1,
wherein the input interface includes a header insertion portion which inserts header information into the inputted frame,
the frame amount detection portion places the detected frame amount into the header information of the frame for the corresponding output interface,
the output interface comprises a header extraction portion which extracts the header information, and a comparison portion which compares the frame amount included in the header information of the frame received from the first switch portion and the frame amount included in the header information of the frame received from the second switch portion and sends the comparison result to the header insertion portion of the corresponding input interface,
the header insertion portion places the comparison result into the header information, and
the scheduler controls reading from the buffer based on the comparison result which is included in the header information of the inputted frame.

4. The data transmission apparatus according to claim 3,
wherein the comparison portion sends information which indicates the switch with the fewest frames to the header insertion portion as the comparison result of the frame amount,
the header insertion portion inserts a header which includes information indicating read-restriction of a frame for the switch with the fewest frames based on the sent information, and
the scheduler halts reading from the buffer of an own switch portion in accordance with presence or absence of the information which indicates the read-restriction.
